(19) United States
(12) Patent Application Publication
(10) Pub. No.: US 2021/0345542 A1
(43) Pub. Date: Nov. 11, 2021

(54) Lawnmower Height Adjusting Assembly

(71) Applicant: Damien Conard, Overland Park, KS (US)

(72) Inventor: Damien Conard, Overland Park, KS (US)

(21) Appl. No.: 16/870,174

(22) Filed: May 8, 2020

(51) Int. Cl. A01D 34/00; A01D 41/14

(52) U.S. Cl. CPC A01D 34/001; A01D 2101/00; A01D 41/145

(57) ABSTRACT

A lawnmower height adjusting assembly for adjusting the height of a lawnmower includes a pump that is coupled to a lawnmower. A lever is movably coupled to a handle of the lawnmower and the lever is in mechanical communication with the pump for turning the pump on and off. A plurality of actuators is provided and each of the actuators is coupled to a deck of the lawnmower. A respective one of a plurality of wheels on the lawnmower is coupled to each of the actuators. Each of the actuators is in fluid communication with the pump and each of the actuators is extended when the pump is turned on. In this way the plurality of actuators lifts the deck of the lawnmower. Each of the actuators is retracted when the pump is turned off. In this way the plurality of actuators lowers the deck of the lawnmower.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to height adjusting devices and more particularly pertains to a new height adjusting device for adjusting the height of a lawnmower.

### (2) Description of Related Art Including Information Disclosed Under 37 CFR 1.97 and 1.98

The prior art relates to height adjusting devices including a linkage that is coupled to a lawnmower which includes a crank that is rotated by a user for lifting or lowering a lawnmower while the lawnmower is being pushed. The prior art also disclose a riding lawn mower that has front wheel suspension and back wheel suspension. The prior art discloses a deck height adjustment for a lawnmower that includes a lever that is manipulated by a user of the lawnmower.

### BRIEF SUMMARY OF THE INVENTION

An embodiment of the disclosure meets the needs presented above by generally comprising a pump that is coupled to a lawnmower. A lever is movably coupled to a handle of the lawnmower and the lever is in mechanical communication with the pump for turning the pump on and off. A plurality of actuators is provided and each of the actuators is coupled to a deck of the lawnmower. A respective one of a plurality of wheels on the lawnmower is coupled to each of the actuators. Each of the actuators is in fluid communication with the pump and each of the actuators is extended when the pump is turned on. In this way the plurality of actuators lifts the deck of the lawnmower. Each of the actuators is retracted when the pump is turned off. In this way the plurality of actuators lowers the deck of the lawnmower.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a lawnmower height adjusting assembly according to an embodiment of the disclosure.

FIG. 2 is a left side view of an embodiment of the disclosure.

FIG. 3 is a top view of an embodiment of the disclosure.

FIG. 4 is a cross sectional view taken along line 4-4 of FIG. 3 of an embodiment of the disclosure.

FIG. 5 is a perspective in-use view of an embodiment of the disclosure showing a plurality of actuators in a retracted position.

FIG. 6 is a perspective view of an embodiment of the disclosure showing a plurality of actuators in an extended position.

### DETAILED DESCRIPTION OF THE INVENTION

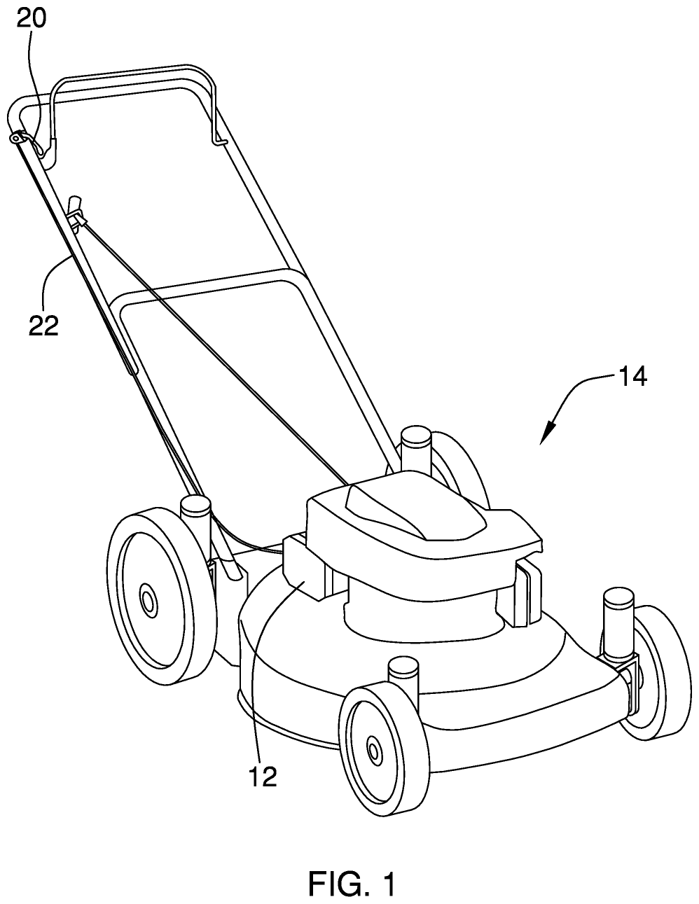

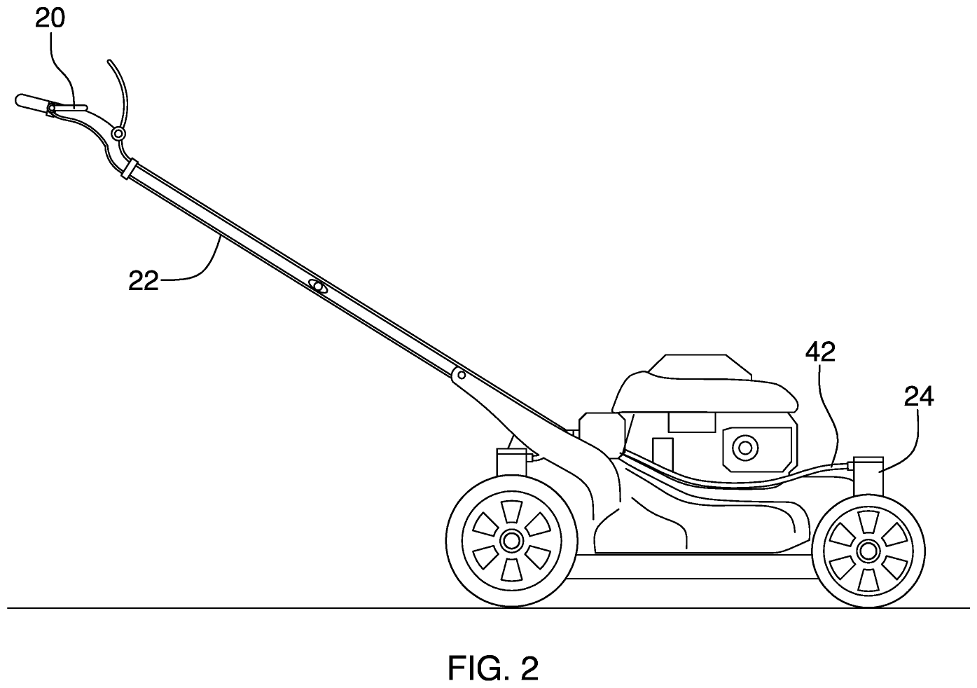

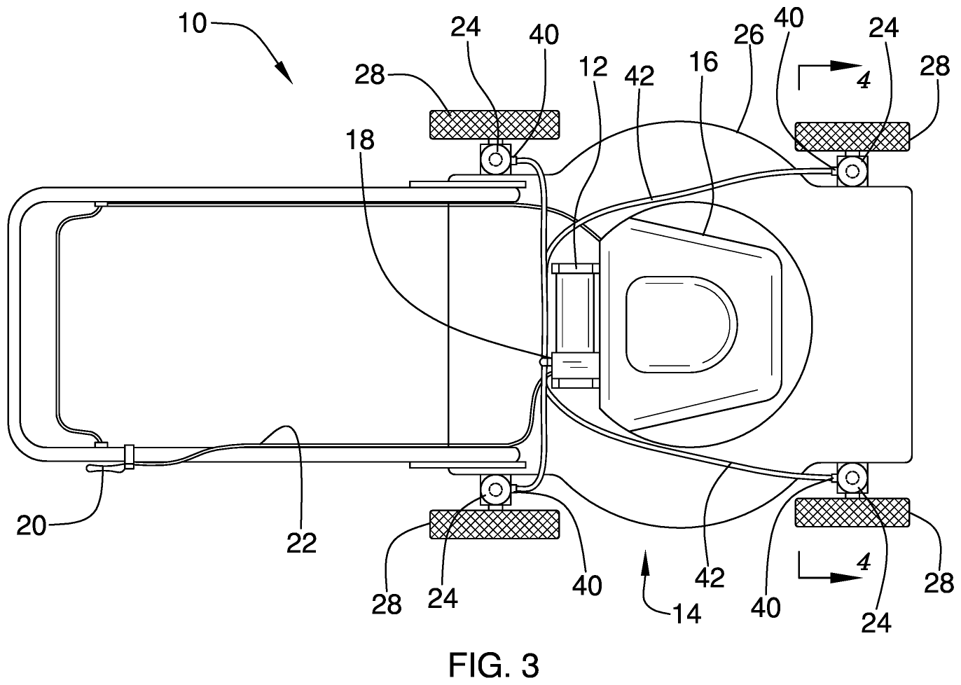

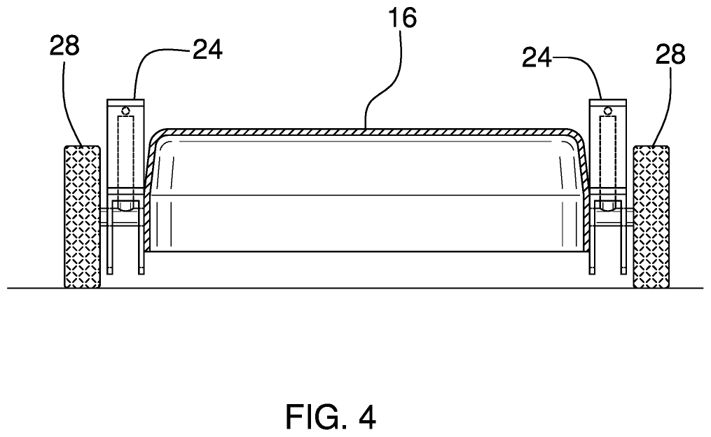

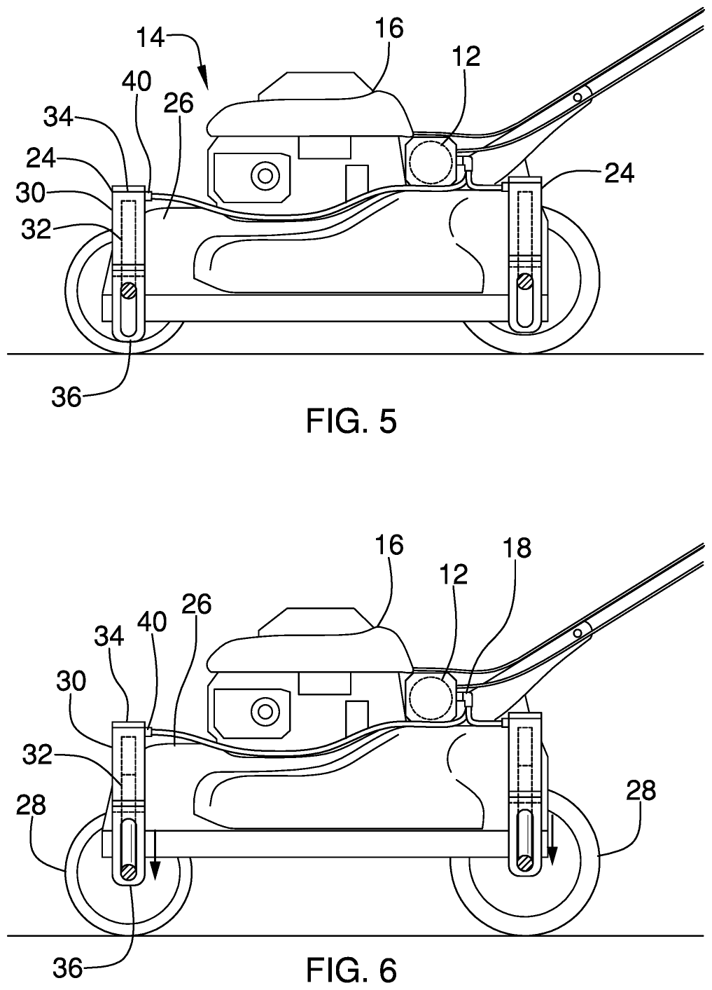

With reference now to the drawings, and in particular to FIGS. 1 through 6 thereof, a new height adjusting device embodying the principles and concepts of an embodiment of the disclosure and generally designated by the reference numeral 10 will be described.

As best illustrated in FIGS. 1 through 6, the lawnmower height adjusting assembly 10 generally comprises a pump 12 that is coupled to a lawnmower 14. The lawnmower 14 may be a push lawnmower of any conventional design, including gas powered lawnmowers and electric lawnmowers. The pump 12 is in mechanical communication with a power source comprising a motor 16 of the lawnmower 14 and the pump 12 has an output 18. The pump 12 may be an air compressor or a hydraulic pump.

A lever 20 is movably coupled to a handle of the lawnmower 14 such that the lever 20 is accessible to a person mowing with the lawnmower 14. The lever 20 is movable in either a lifting direction or a lowering direction. A cable 22 is coupled between the lever 20 and the pump 12 such that the lever 20 is in mechanical communication with the pump 12. The pump 12 is actuated into a lifting condition having the pump 12 urging air, or hydraulic fluid, outwardly therefrom when the lever 20 is moved in the lifting direction. The pump 12 is actuated into a lowering condition having the pump 12 facilitating air, or hydraulic fluid, to pass unimpeded through the pump 12 when the lever 20 is moved in the lowering direction.

A plurality of actuators 24 is provided and each coupled to a deck 26 of the lawnmower 14. Moreover, each of the actuators 24 has a respective one of a plurality of wheels 28 on the lawnmower 14 coupled thereto, and each of the actuators 24 is in fluid communication with the pump 12. Each of the actuators 24 is extended when the pump 12 is actuated into the lifting condition to lift the deck 26 of the lawnmower 14. Conversely, each of the actuators 24 is retracted when the pump 12 is actuated into the lowering condition to lower the deck 26 of the lawnmower 14. In this way the deck 26 of the lawnmower 14 can be adjusted while the user is mowing grass, thereby facilitating the lawnmower 14 to pass over obstacles without risk of damaging the lawnmower 14.

Each of the actuators 24 has a first portion 30 that slidably engages a second portion 32 such that each of the actuators 24 has a telescopically adjustable length. The first portion 30 has a first end 34 and the second portion 32 has a second end 36. The first end 34 is spaced upwardly from the deck 26 of the lawnmower 14 and the second end 36 is coupled to the respective wheel 28. The second end 36 is urged away from the first end 34 when the actuators 24 are extended and the second end 36 is urged toward the first end 34 when the actuators 24 are retracted. Moreover, each of the actuators 24 has an input 40 that is in fluid communication with the first portion 30. Each of the actuators 24 may comprise an air piston, a hydraulic piston or other similar type of linear actuator. A plurality of conduits 42 is each fluidly coupled between the outlet of the pump 12 and the input 40 of a respective one of the actuators 24.

In use, the lever 20 is moved into the lifting position to raise the deck 26 while the lawnmower 14 is being pushed. In this way the lawnmower 14 can pass over an obstacle, such as a brick or an ornamental feature, without damaging the lawnmower 14. The lever 20 is moved into the lowering position to lower the deck 26 while the lawnmower 14 is being pushed. Thus, the actuators 24 facilitate the height of the lawnmower 14 to be adjusted at any time without requiring the user to stop pushing the lawnmower 14 and manually adjust the height of the lawnmower 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lawnmower height adjusting assembly for automatically adjusting the height of a lawnmower deck during mowing, said assembly comprising:
a pump being coupled to a lawnmower, said pump being in mechanical communication with a power source comprising a motor of the lawnmower;
a lever being movably coupled to a handle of the lawnmower wherein said lever is configured to accessible to a person mowing with the lawnmower, said lever being in mechanical communication with said pump for turning said pump on and off; and
a plurality of actuators, each of said actuators being coupled to a deck of the lawnmower, each of said actuators having a respective one of a plurality of wheels on the lawnmower being coupled thereto, each of said actuators being in fluid communication with said pump, each of said actuators being extended when said pump is turned on wherein said plurality of actuators is configured to lift the deck of the lawnmower, each of said actuators being retracted when said pump is turned off wherein said plurality of actuators is configured to lower the deck of the lawnmower.

2. The assembly according to claim 1, wherein:
said lever is movable in either a lifting direction or a lowering direction; and
said assembly includes a cable being coupled between said lever and said pump such that said lever is in mechanical communication with said pump, said pump being actuated into a lifting condition having said pump urging air outwardly therefrom when said lever is moved in said lifting direction, said pump being actuated into a lowering condition having said pump facilitating air to pass unimpeded through said pump when said lever is moved in said lowering direction.

3. The assembly according to claim 2, wherein each of said actuators is extended when said pump is actuated into said lifting condition wherein said plurality of actuators is configured to lift the deck of the lawnmower, each of said actuators being retracted when said pump is actuated into said lowering condition wherein said plurality of actuators is configured to lower the deck of the lawnmower.

4. The assembly according to claim 1, wherein each of said actuators has a first portion slidably engaging a second portion such that each of said actuators has a telescopically adjustable length, said first portion having a first end, said second portion having a second end, said first end being spaced upwardly from the deck of the lawnmower, said second end being coupled to the respective wheel.

5. The assembly according to claim 4, wherein said second end is urged away from said first end when said actuators are extended, said second end being urged toward said first end when said actuators are retracted, each of said actuators having an input being in fluid communication with said first portion.

6. The assembly according to claim 5, wherein:
said pump has an output; and
a plurality of conduits, each of said conduits being fluidly coupled between said outlet of said pump and said input of a respective one of said actuators.

7. A lawnmower height adjusting assembly for automatically adjusting the height of a lawnmower deck during mowing, said assembly comprising:
a pump being coupled to a lawnmower, said pump being in mechanical communication with a power source comprising a motor of the lawnmower, said pump having an output;
a lever being movably coupled to a handle of the lawnmower wherein said lever is configured to accessible to a person mowing with the lawnmower, said lever being movable in either a lifting direction or a lowering direction;
a cable being coupled between said lever and said pump such that said lever is in mechanical communication with said pump, said pump being actuated into a lifting condition having said pump urging air outwardly therefrom when said lever is moved in said lifting direction, said pump being actuated into a lowering condition having said pump facilitating air to pass unimpeded through said pump when said lever is moved in said lowering direction;
a plurality of actuators, each of said actuators being coupled to a deck of the lawnmower, each of said actuators having a respective one of a plurality of wheels on the lawnmower being coupled thereto, each of said actuators being in fluid communication with said pump, each of said actuators being extended when said pump is actuated into said lifting condition wherein said plurality of actuators is configured to lift the deck of the lawnmower, each of said actuators being retracted when said pump is actuated into said lowering condition wherein said plurality of actuators is configured to lower the deck of the lawnmower, each of said actuators having a first portion slidably engaging a second portion such that each of said actuators has a telescopically adjustable length, said first portion having a first end, said second portion having a second end, said first end being spaced upwardly from the deck of the lawnmower, said second end being coupled to the respective wheel, said second end being urged away from said first end when said actuators are extended, said second end being urged toward said first end when said actuators are retracted, each of said actuators having an input being in fluid communication with said first portion; and
a plurality of conduits, each of said conduits being fluidly coupled between said outlet of said pump and said input of a respective one of said actuators.

8. A lawnmower lifting system for automatically adjusting the height of a lawnmower deck during mowing, said assembly comprising:
a lawnmower having a deck, a motor, a handle and a plurality of wheels;
a pump being coupled to said lawnmower, said pump being in mechanical communication with a power source comprising said motor of said lawnmower, said pump having an output;
a lever being movably coupled to said handle of said lawnmower wherein said lever is configured to accessible to a person mowing with said lawnmower, said lever being movable in either a lifting direction or a lowering direction;
a cable being coupled between said lever and said pump such that said lever is in mechanical communication with said pump, said pump being actuated into a lifting condition having said pump urging air outwardly therefrom when said lever is moved in said lifting direction, said pump being actuated into a lowering condition having said pump facilitating air to pass unimpeded through said pump when said lever is moved in said lowering direction;
a plurality of actuators, each of said actuators being coupled to said deck of said lawnmower, each of said actuators having a respective one of said wheels on said lawnmower being coupled thereto, each of said actuators being in fluid communication with said pump, each of said actuators being extended when said pump is actuated into said lifting condition wherein said plurality of actuators is configured to lift the deck of the lawnmower, each of said actuators being retracted when said pump is actuated into said lowering condition wherein said plurality of actuators is configured to lower the deck of the lawnmower, each of said actuators having a first portion slidably engaging a second portion such that each of said actuators has a telescopically adjustable length, said first portion having a first end, said second portion having a second end, said first end being coupled to said deck of said lawnmower, said second end being coupled to said respective wheel, said second end being urged away from said first end when said actuators are extended, said second end being urged toward said first end when said actuators are retracted, each of said actuators having an input being in fluid communication with said first portion; and
a plurality of conduits, each of said conduits being fluidly coupled between said outlet of said pump and said input of a respective one of said actuators.
